(19) United States
(12) Patent Application Publication
(10) Pub. No.: US 2026/0350144 A1
(43) Pub. Date: Nov. 5, 2026

(54) System and Method for Dynamic Workspace Orchestration

(71) Applicant: Timu, LLC, Irvine, CA (US)

(72) Inventors: Parsa J. Rohani, Laguna Beach, CA (US); Jesse Ezell, Newport Coast, CA (US)

(21) Appl. No.: 19/665,286

(22) Filed: May 1, 2026

Related U.S. Application Data
(60) Provisional application No. 63/798,779, filed on May 2, 2025.

(51) Int. Cl. G06F 21/53; G06F 9/50

(52) U.S. Cl. CPC G06F 21/53; G06F 9/5077

(57) ABSTRACT

A method, computer program product, and computer system for processing a request for a secure dynamic workspace in a cloud computing environment. In response to processing the request, the secure dynamic workspace is generated in the cloud computing environment by provisioning a plurality of cloud computing resources for use within the secure dynamic workspace. One or more artificial intelligence (AI) agents are deployed within the secure dynamic workspace using the plurality of cloud computing resources. One or more interactions with the one or more AI agents are processed using content information defined within the secure dynamic workspace. A state for the one or more AI agents is managed within secure dynamic workspace based upon, at least in part, the one or more interactions.

### RELATED CASES

This application claims the benefit of U.S. Provisional Application No. 63/798,779, filed on 2 May. 2025, the contents of which is incorporated by reference.

### BACKGROUND

The rapid proliferation of artificial intelligence (AI) agents in enterprise environments has given rise to a broad ecosystem of tools and platforms for building, deploying, and managing such agents. Existing approaches generally fall into two categories: agent builders, which provide frameworks for defining and assembling agent logic, and agent runtimes, which provide managed environments for executing agent processes. Platforms in the first category, such as multi-agent orchestration frameworks and graph-based agent composition tools, focus on enabling developers to define agent behaviors, tool integrations, and inter-agent communication patterns. Platforms in the second category provide cloud-hosted infrastructure for running agent workloads, often abstracting away the underlying compute and model-serving concerns. However, both categories share a common architectural limitation: they treat the agent definition itself as the fundamental unit of infrastructure. As a result, when organizations seek to operate large numbers of uniquely configured agent deployments in production, each potentially requiring distinct state, security boundaries, configuration parameters, and synchronization protocols, existing platforms offer no coherent abstraction for managing the agent instance as a discrete, self-contained operational unit. The gap between building an individual agent and orchestrating thousands of independently configured agent workspaces at scale remains largely unaddressed by conventional approaches.

A further limitation of existing systems is their prevailing assumption that agent interactions follow a single-player, request-response paradigm, in which a single user issues a prompt or instruction and a single agent returns a result. This model fails to account for the increasingly collaborative nature of enterprise work, where multiple human participants and multiple agents must operate concurrently within a shared context, maintaining synchronized state and coordinated access to resources. Conventional architectures lack a unified boundary that encapsulates state, security policy, agent configuration, compute allocation, and real-time synchronization within a single, self-contained construct. Without such a boundary, organizations are forced to assemble disparate infrastructure components, including separate state stores, access-control layers, configuration management systems, and messaging frameworks, and to manually coordinate them for each deployment instance. This fragmented approach introduces significant complexity, increases the attack surface for security vulnerabilities, and inhibits the dynamic provisioning and teardown of isolated collaborative workspaces.

### BRIEF SUMMARY OF DISCLOSURE

In one example implementation, a method, performed by one or more computing devices, may include but is not limited to processing a request for a secure dynamic workspace in a cloud computing environment. In response to processing the request, the secure dynamic workspace is generated in the cloud computing environment by provisioning a plurality of cloud computing resources for use within the secure dynamic workspace. One or more artificial intelligence (AI) agents are deployed within the secure dynamic workspace using the plurality of cloud computing resources. One or more interactions with the one or more AI agents are processed using content information defined within the secure dynamic workspace. A state for the one or more AI agents is managed within secure dynamic workspace based upon, at least in part, the one or more interactions.

One or more of the following example features may be included. The secure dynamic workspace may be a virtual container configured to isolate the plurality of cloud computing resources based upon, at least in part, a security policy defined for the secure dynamic workspace. Communication traffic for the secure dynamic workspace may be processed using a mesh protocol layer. Processing communication traffic for the secure dynamic workspace using the mesh protocol layer may include: receiving a communication packet from a first user at a first mesh protocol layer node associated with the secure dynamic workspace; processing the communication packet within the secure dynamic workspace; and transmitting the communication packet to a second user from a second mesh protocol layer node associated with the secure dynamic workspace. Processing the one or more interactions with the one or more AI agents may include managing credential information for an external computing resource container accessible to the one or more AI agents. Generating the secure dynamic workspace in the cloud computing environment may include provisioning a persistent storage volume within the secure dynamic workspace. The secure dynamic workspace may be maintained while a connection is identified by the mesh protocol layer between the secure dynamic workspace and at least one user.

In another example implementation, a computing system may include one or more processors and one or more memories configured to process a request for a secure dynamic workspace in a cloud computing environment. In response to processing the request, the secure dynamic workspace is generated in the cloud computing environment by provisioning a plurality of cloud computing resources for use within the secure dynamic workspace. One or more artificial intelligence (AI) agents are deployed within the secure dynamic workspace using the plurality of cloud computing resources. One or more interactions with the one or more AI agents are processed using content information defined within the secure dynamic workspace. A state for the one or more AI agents is managed within secure dynamic workspace based upon, at least in part, the one or more interactions.

One or more of the following example features may be included. The secure dynamic workspace may be a virtual container configured to isolate the plurality of cloud computing resources based upon, at least in part, a security policy defined for the secure dynamic workspace. Communication traffic for the secure dynamic workspace may be processed using a mesh protocol layer. Processing communication traffic for the secure dynamic workspace using the mesh protocol layer may include: receiving a communication packet from a first user at a first mesh protocol layer node associated with the secure dynamic workspace; processing the communication packet within the secure dynamic workspace; and transmitting the communication packet to a second user from a second mesh protocol layer node associated with the secure dynamic workspace. Processing the one or more interactions with the one or more AI agents may include managing credential information for an external computing resource container accessible to the one or more AI agents. Generating the secure dynamic workspace in the cloud computing environment may include provisioning a persistent storage volume within the secure dynamic workspace. The secure dynamic workspace may be maintained while a connection is identified by the mesh protocol layer between the secure dynamic workspace and at least one user.

In another example implementation, a computer program product may reside on a computer readable storage medium having a plurality of instructions stored thereon which, when executed across one or more processors, may cause at least a portion of the one or more processors to perform operations that may include but are not limited to processing a request for a secure dynamic workspace in a cloud computing environment. In response to processing the request, the secure dynamic workspace is generated in the cloud computing environment by provisioning a plurality of cloud computing resources for use within the secure dynamic workspace. One or more artificial intelligence (AI) agents are deployed within the secure dynamic workspace using the plurality of cloud computing resources. One or more interactions with the one or more AI agents are processed using content information defined within the secure dynamic workspace. A state for the one or more AI agents is managed within secure dynamic workspace based upon, at least in part, the one or more interactions.

One or more of the following example features may be included. The secure dynamic workspace may be a virtual container configured to isolate the plurality of cloud computing resources based upon, at least in part, a security policy defined for the secure dynamic workspace. Communication traffic for the secure dynamic workspace may be processed using a mesh protocol layer. Processing communication traffic for the secure dynamic workspace using the mesh protocol layer may include: receiving a communication packet from a first user at a first mesh protocol layer node associated with the secure dynamic workspace; processing the communication packet within the secure dynamic workspace; and transmitting the communication packet to a second user from a second mesh protocol layer node associated with the secure dynamic workspace. Processing the one or more interactions with the one or more AI agents may include managing credential information for an external computing resource container accessible to the one or more AI agents. Generating the secure dynamic workspace in the cloud computing environment may include provisioning a persistent storage volume within the secure dynamic workspace. The secure dynamic workspace may be maintained while a connection is identified by the mesh protocol layer between the secure dynamic workspace and at least one user.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a dynamic workspace orchestration process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a dynamic workspace orchestration process according to one or more example implementations of the disclosure; and

FIGS. 4-9 are example diagrammatic views of the dynamic workspace orchestration process according to one or more example implementations of the disclosure.

Like reference symbols in the various drawings may indicate like elements.

### DETAILED DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java^{®}, Smalltalk, C++ or the like. Java^{®} and all Java-based trademarks and logos are trademarks or registered trademarks of Oracle and/or its affiliates. However, the computer program code for carrying out operations of the present disclosure may also be written in conventional procedural programming languages, such as the "C" programming language, PASCAL, or similar programming languages, as well as in scripting languages such as Javascript, PERL, or Python. The program code may execute entirely on the user’s computing device, partly on the user’s computing device, as a stand-alone software package, partly on the user’s computer and partly on a remote computer or entirely on the remote computer or server. In the latter scenario, the remote computer may be connected to the user’s computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

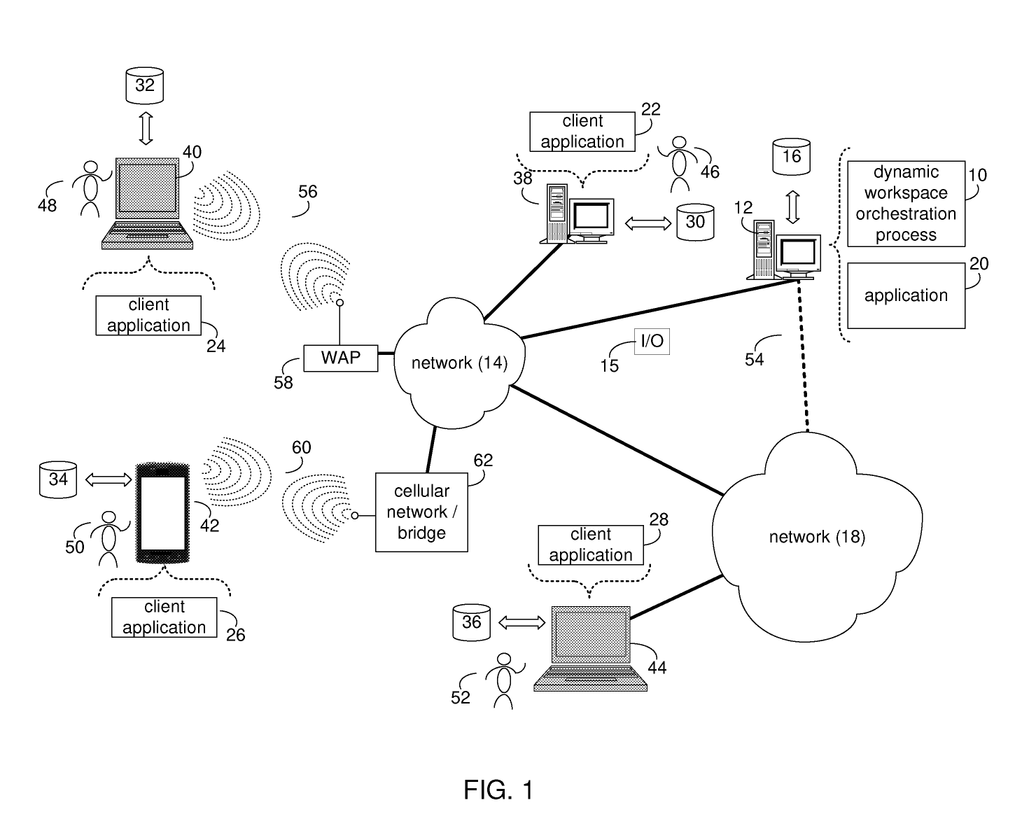

Referring now to the example implementation of FIG. 1, there is shown dynamic workspace orchestration process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a dynamic workspace orchestration process, such as dynamic workspace orchestration process 10 of FIG. 1, may process a request for a secure dynamic workspace in a cloud computing environment. In response to processing the request, the secure dynamic workspace is generated in the cloud computing environment by provisioning a plurality of cloud computing resources for use within the secure dynamic workspace. One or more artificial intelligence (AI) agents are deployed within the secure dynamic workspace using the plurality of cloud computing resources. One or more interactions with the one or more AI agents are processed using content information defined within the secure dynamic workspace. A state for the one or more AI agents is managed within secure dynamic workspace based upon, at least in part, the one or more interactions.

In some implementations, the instruction sets and subroutines of dynamic workspace orchestration process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase "telecommunications network facility," as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, dynamic workspace orchestration process 10 may be a component of the data store, a standalone application that interfaces with the above noted data store and/or an applet / application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute an application (e.g., application 20), examples of which may include, but are not limited to, e.g., a collaboration application allowing for the sharing of content across multiple computing devices, a cloud storage application that enables users to create and manage content within a cloud storage service, etc. In some implementations, dynamic workspace orchestration process 10 and/or application 20 may be accessed via one or more of client applications 22, 24, 26, 28. In some implementations, dynamic workspace orchestration process 10 may be a standalone application, or may be an applet / application / script / extension that may interact with and/or be executed within application 20, a component of application 20, and/or one or more of client applications 22, 24, 26, 28. In some implementations, application 20 may be a standalone application, or may be an applet / application / script / extension that may interact with and/or be executed within dynamic workspace orchestration process 10, a component of dynamic workspace orchestration process 10, and/or one or more of client applications 22, 24, 26, 28. In some implementations, one or more of client applications 22, 24, 26, 28 may be a standalone application, or may be an applet / application / script / extension that may interact with and/or be executed within and/or be a component of dynamic workspace orchestration process 10 and/or application 20. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone (such as those embedded within eyeglasses, smart phones, tablet computers and/or watches, etc.), and a dedicated network device. Client electronic devices 38, 40, 42, 44 may each execute an operating system, examples of which may include but are not limited to, Android^{TM}, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of dynamic workspace orchestration process 10 (and vice versa). Accordingly, in some implementations, dynamic workspace orchestration process 10 may be a purely server-side application, a purely client-side application, or a hybrid server-side / client-side application that is cooperatively executed by one or more of client applications 22, 24, 26, 28 and/or dynamic workspace orchestration process 10.

In some implementations, one or more of client applications 22, 24, 26, 28 may be configured to effectuate some or all of the functionality of application 20 (and vice versa). Accordingly, in some implementations, application 20 may be a purely server-side application, a purely client-side application, or a hybrid server-side / client-side application that is cooperatively executed by one or more of client applications 22, 24, 26, 28 and/or application 20. As one or more of client applications 22, 24, 26, 28, dynamic workspace orchestration process 10, and application 20, taken singly or in any combination, may effectuate some or all of the same functionality, any description of effectuating such functionality via one or more of client applications 22, 24, 26, 28, dynamic workspace orchestration process 10, application 20, or combination thereof, and any described interaction(s) between one or more of client applications 22, 24, 26, 28, dynamic workspace orchestration process 10, application 20, or combination thereof to effectuate such functionality, should be taken as an example only and not to limit the scope of the disclosure.

In some implementations, one or more of users 46, 48, 50, 52 may access computer 12 and dynamic workspace orchestration process 10 (e.g., using one or more of client electronic devices 38, 40, 42, 44) directly through network 14 or through secondary network 18. Further, computer 12 may be connected to network 14 through secondary network 18, as illustrated with phantom link line 54. Dynamic workspace orchestration process 10 may include one or more user interfaces, such as browsers and textual or graphical user interfaces, through which users 46, 48, 50, 52 may access dynamic workspace orchestration process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth^{TM} (including Bluetooth^{TM} Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network / bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth^{TM} (including Bluetooth^{TM} Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12 (and vice versa). Examples of I/O request 15 may include but are not limited to, data write requests (e.g., a request that content be written to computer 12) and data read requests (e.g., a request that content be read from computer 12).

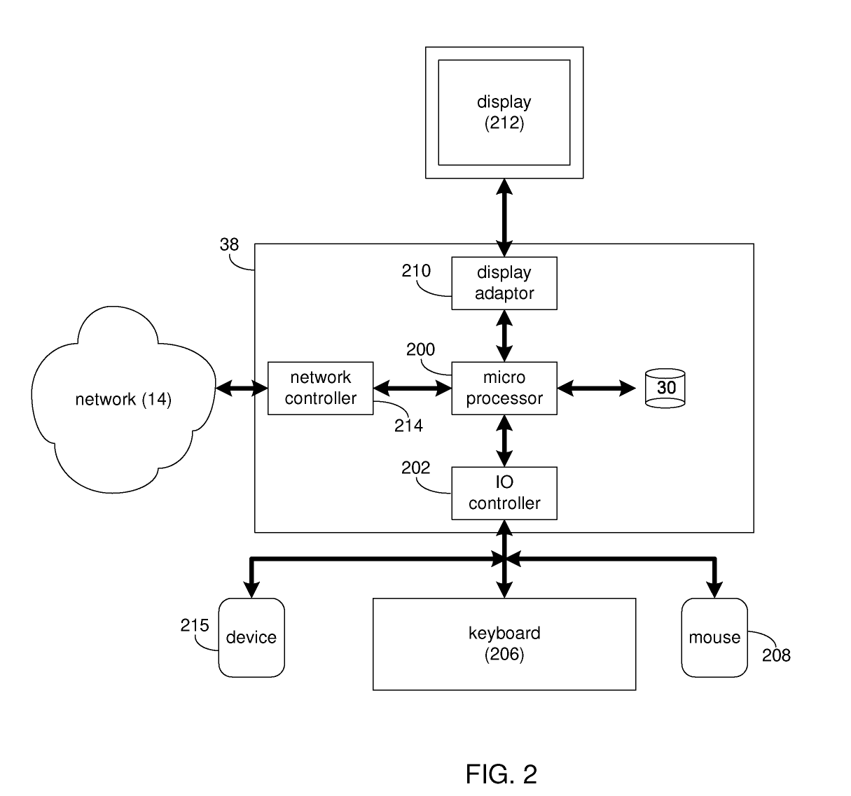

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, dynamic workspace orchestration process 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor (e.g., microprocessor 200) configured to, e.g., process data and execute the above-noted code / instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

### The Dynamic Workspace Orchestration Process

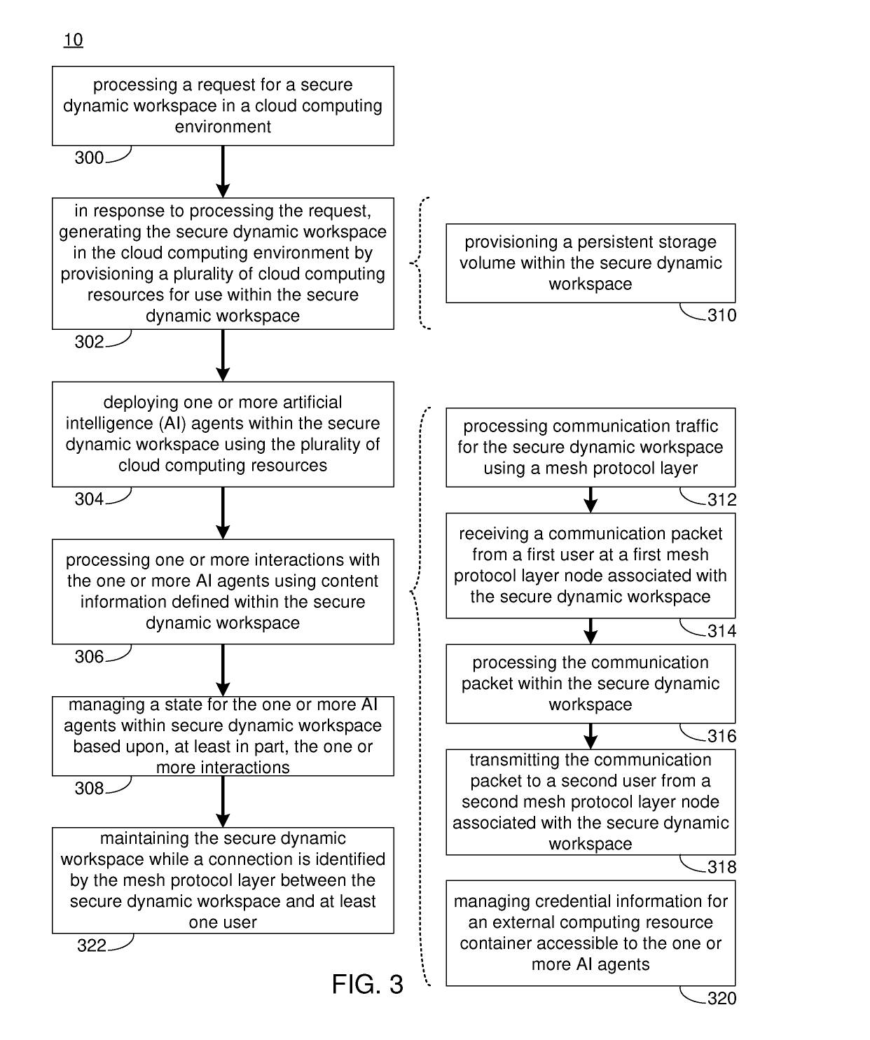

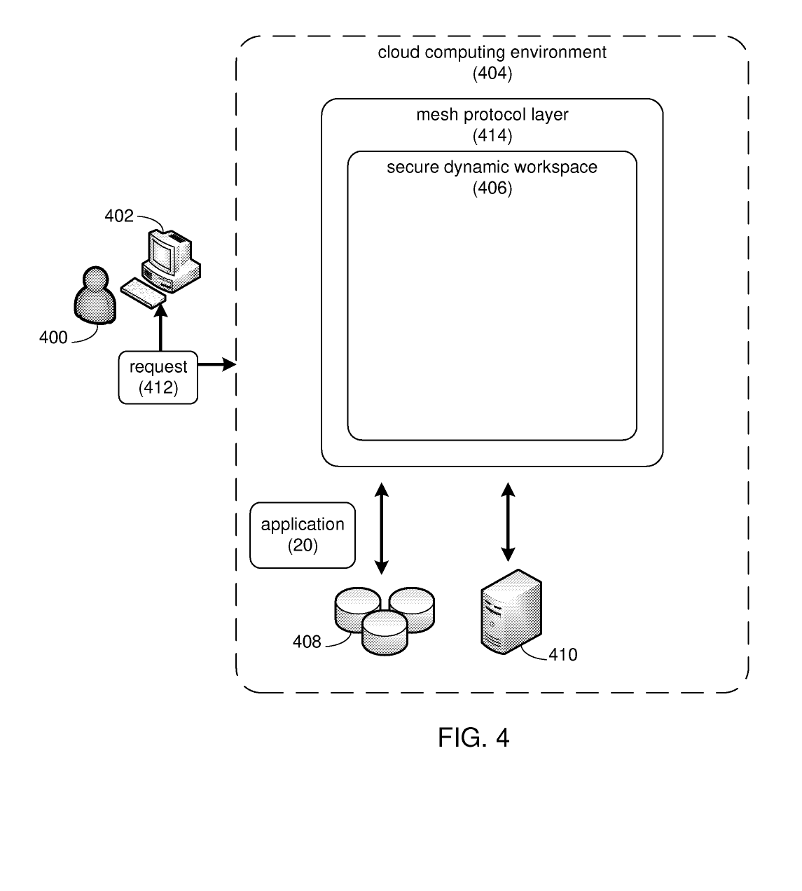

As discussed above and referring also at least to the example implementations of FIGS. 3-9, dynamic workspace orchestration process 10 may process 300 a request for a secure dynamic workspace in a cloud computing environment. In response to processing the request, the secure dynamic workspace is generated 302 in the cloud computing environment by provisioning a plurality of cloud computing resources for use within the secure dynamic workspace. One or more artificial intelligence (AI) agents are deployed 304 within the secure dynamic workspace using the plurality of cloud computing resources. One or more interactions with the one or more AI agents are processed 306 using content information defined within the secure dynamic workspace. A state for the one or more AI agents is managed 308 within secure dynamic workspace based upon, at least in part, the one or more interactions.

Implementations of the present disclosure generate and orchestrate secure dynamic workspaces for users and artificial intelligence (AI) agents. For example and as discussed above, the rapid proliferation of AI agents (or “agents”) in enterprise environments has given rise to a broad ecosystem of agent builders, which provide frameworks for defining and assembling agent logic, and agent runtimes, which provide managed environments for executing agent processes. Agent builders, such as multi-agent orchestration frameworks and graph-based composition tools, focus on defining agent behaviors, tool integrations, and inter-agent communication patterns, while agent runtimes provide cloud-hosted infrastructure that abstracts underlying compute and model-serving concerns. Both categories, however, treat the agent definition as the fundamental unit of infrastructure. When organizations seek to operate large numbers of uniquely configured agent deployments in production, each requiring distinct state, security boundaries, configuration parameters, and synchronization protocols, existing platforms offer no coherent abstraction for managing the agent instance as a discrete, self-contained operational unit.

Existing systems further assume that agent interactions follow a single-player, request-response paradigm, failing to account for enterprise workflows in which multiple human participants and multiple agents must operate concurrently within a shared context, maintaining synchronized state and coordinated access to resources. Conventional architectures lack a unified boundary encapsulating state, security policy, agent configuration, compute allocation, and real-time synchronization within a single construct, forcing organizations to assemble and coordinate disparate infrastructure components, including separate state stores, access-control layers, configuration management systems, and messaging frameworks, for each deployment instance. This fragmented approach introduces significant complexity, increases the attack surface for security vulnerabilities, and inhibits dynamic provisioning and teardown of isolated collaborative workspaces. Accordingly, implementations of the present disclosure generate and orchestrate a secure, self-contained dynamic workspace instance as the core infrastructure primitive, enabling dynamic generation, orchestration, and lifecycle management of collaborative environments in which multiple agents and human participants operate over shared, synchronized state within a unified security and compute boundary.

In some implementations, dynamic workspace orchestration process 10 may process 300 a request for a secure dynamic workspace in a cloud computing environment. For example, a user (e.g., user 400) may use a computing device (e.g., computing device 402) to access a cloud computing environment (e.g., cloud computing environment 404). In this example, user 400 may desire a secure dynamic workspace deployed in cloud computing environment 404. In some implementations, a secure dynamic workspace is a virtual container configured to isolate a plurality of cloud computing resources based upon, at least in part, a security policy defined for the secure dynamic workspace. In this example, secure dynamic workspace (secure dynamic workspace 406) may be defined using cloud computing resources (e.g., cloud computing storage resources 408 and cloud computing compute resources 410) and a security policy that describes one or more limitations on the users and AI agents that may operate within the secure dynamic workspace and the scope of permissions associated AI agents deployed within secure dynamic workspace 406. Accordingly, dynamic workspace orchestration process 10 may process 300 a request (e.g., request 412) from user 400’s computing device (e.g., computing device 402) describing cloud computing resources and security policy information associated with secure dynamic workspace 406. In some implementations, dynamic workspace orchestration process 10 may dynamic workspace orchestration process 10 a request (e.g., request 412) for secure dynamic workspace 406 and may generate one or more secure dynamic workspaces as a function of the constraints of cloud computing environment 404 and the constraints of request 412. While an example of a single secure dynamic workspace will be described in various examples below, it will be appreciated that this is for example purposes only and that any number of secure dynamic workspaces may be generated within the scope of the present disclosure.

In some implementations, dynamic workspace orchestration process 10 may, in response to processing the request, generate 302 the secure dynamic workspace in the cloud computing environment by provisioning a plurality of cloud computing resources for use within the secure dynamic workspace. For example, with request 412, dynamic workspace orchestration process 10 may generate 302 secure dynamic workspace 406 in cloud computing environment 400 by provisioning or assigning a plurality of cloud computing resources for use by secure dynamic workspace 406. In some implementations, cloud computing environments provide a variety of storage and compute resources that may be provisioned to support dynamic workspaces. Cloud computing storage resources (e.g., cloud computing storage resources 408) include, without limitation, object storage services for storing unstructured data as discrete objects within buckets or containers, block storage services that provide persistent storage volumes attachable to virtual machine instances, and file storage services that expose shared file systems accessible by multiple compute instances over standard network protocols. Cloud computing storage resources further include managed database services, encompassing both relational database engines and non-relational or NoSQL data stores, as well as in-memory data stores and caching services that maintain data in volatile memory for low-latency read and write operations. Additional storage resources include data warehouse and analytics storage services optimized for large-scale analytical queries across structured datasets, and archival or cold storage services designed for long-term retention of infrequently accessed data at reduced cost.

In some implementations, cloud computing compute resources (e.g., cloud computing compute resources 410) include virtual machine instances that provide configurable allocations of processing capacity, memory, and network bandwidth on shared or dedicated physical hardware. Cloud computing compute resources further include container instances and container orchestration services that execute application workloads within isolated, lightweight runtime environments managed across clusters of host machines. Serverless or function-as-a-service compute resources execute discrete units of application logic in response to triggering events without requiring the provisioning or management of underlying server infrastructure. Specialized compute resources include graphics processing unit and hardware accelerator instances optimized for artificial intelligence, machine learning, and parallel processing workloads, as well as batch and high-performance computing services that coordinate the execution of large-scale computational jobs across distributed resource pools. Edge compute resources extend cloud computing capabilities to geographically distributed locations closer to end users or data sources, enabling reduced-latency processing at the network periphery. In various implementations, a secure dynamic workspace may be provisioned with one or more of the foregoing storage and compute resources, each workspace instance receiving an allocated subset of resources configured in accordance with its associated security policy, workload requirements, and operational parameters.

In one example, dynamic workspace orchestration process 10 may process 300 a request for secure dynamic workspace 406 by intercepting a first request for secure dynamic workspace 406 from user 400. Dynamic workspace orchestration process 10 may generate 302 secure dynamic workspace 406 by issuing a creation request (e.g., a Kubernetes job or deployment request) to define secure dynamic workspace 406. Dynamic workspace orchestration process 10 may tunnel the new or subsequent connections (e.g., WebSocket connections) directly into secure dynamic workspace 406 upon generation.

In some implementations, generating 302 the secure dynamic workspace in the cloud computing environment may include provisioning 310 a persistent storage volume within the secure dynamic workspace. For example, dynamic workspace orchestration process 10 may provision 310 each secure dynamic workspace by default with a persistent storage volume upon instantiation. A persistent storage volume is a block-level or file-level storage resource that retains stored data independently of the lifecycle of any individual compute process, container, or virtual machine instance operating within the secure dynamic workspace. Unlike ephemeral or volatile storage, which is deallocated and its contents discarded when an associated compute process terminates or restarts, a persistent storage volume maintains data durably on underlying physical or virtualized storage media such that the data remains available across process restarts, failovers, and successive computational sessions within the secure dynamic workspace. During operation of secure dynamic workspace 406, AI agents, users, and orchestration processes may read from and write to the persistent storage volume to store workspace state, configuration data, intermediate computational results, conversation histories, generated artifacts, and other workspace-associated data objects. The persistent storage volume is logically bound to the secure dynamic workspace instance and is isolated from persistent storage volumes associated with other secure dynamic workspace instances, thereby ensuring that data written by participants and agents within one workspace is not accessible to participants or agents operating within a different workspace absent explicit authorization. The persistent storage volume remains provisioned and retains its stored data for the duration of the secure dynamic workspace’s lifecycle, from instantiation through active operation and until the secure dynamic workspace is terminated or decommissioned, at which point the persistent storage volume may be deallocated and its contents securely deleted in accordance with applicable data retention and disposal policies.

In some implementations, dynamic workspace orchestration process 10 may deploy 304 one or more artificial intelligence (AI) agents within the secure dynamic workspace using the plurality of cloud computing resources. An artificial intelligence (AI) agent is a software system that receives inputs from its environment, processes those inputs using one or more machine learning models or reasoning engines and takes autonomous or semi-autonomous actions to accomplish defined objectives. Unlike conventional software applications that execute fixed, deterministic instructions, AI agents are characterized by their capacity to perceive context, reason over available information, plan sequences of actions, invoke external tools or application programming interfaces, and adapt their behavior based on intermediate results or changing conditions. AI agents may be implemented using large language models, reinforcement learning models, rule-based inference engines, or combinations thereof, and may range in complexity from single-purpose assistants that perform narrow tasks, such as summarizing a document or querying a database, to multi-step autonomous agents capable of decomposing complex goals into subtasks, delegating work to other agents, and iterating on outputs until a satisfactory result is achieved.

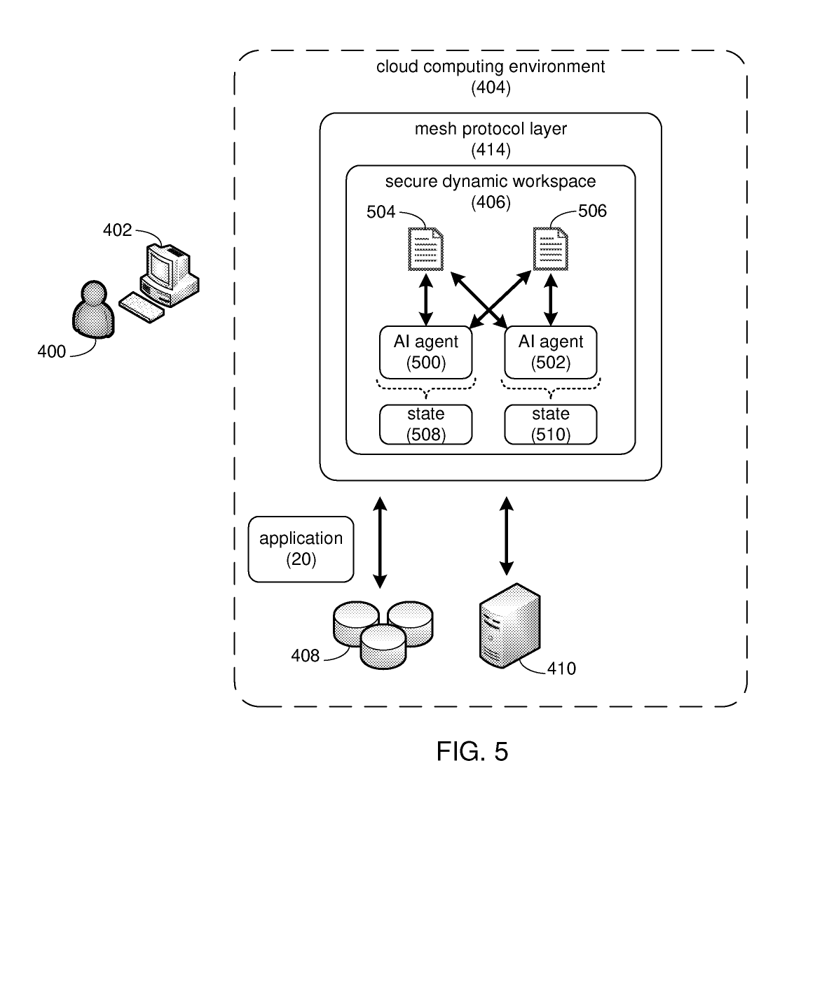

In some implementations and as shown in FIG. 5, AI agents (e.g., AI agents 500, 502) are generally deployed across a wide range of enterprise and consumer environments, including cloud computing platforms, on-premises data centers, edge computing infrastructure, and hybrid environments that span multiple deployment targets. In enterprise settings, AI agents are commonly deployed to automate workflows in domains such as customer support, software engineering, legal research, financial analysis, supply chain management, and information technology operations. Deployment architectures vary and may include single-agent configurations in which one AI agent handles a defined task pipeline, as well as multi-agent configurations in which multiple specialized agents collaborate, share information, and coordinate actions to accomplish broader objectives. AI agents may be deployed as containerized microservices orchestrated within cluster management platforms, as serverless functions triggered by events or API calls, or as persistent processes operating within dedicated virtual machine instances. In each case, the deploying organization provisions and manages the underlying compute, storage, networking, and security resources necessary to support agent execution, data persistence, inter-agent communication, and access control.

In some implementations, dynamic workspace orchestration process 10 enables the deployment of AI agents 500, 502 in secure dynamic workspace 406 such that AI agents 500, 502 are able to access content within secure dynamic workspace 406 and to communicate with other AI agents and/or users within but are unable to access content outside of secure dynamic workspace 406 or to communicate with AI agents and/or users outside of secure dynamic workspace 406. In this manner and unlike conventional approaches which are unable to limit or gate access to content for or interactions with other AI agents and users, dynamic workspace orchestration process 10 provides AI agents 500, 502 with secured and limited to access to content, other AI agents, and/or users that is within or accessible to secure dynamic workspace 406.

Accordingly, dynamic workspace orchestration process 10 may deploy 304 one or more AI agents (e.g., AI agents 500, 502). In this example, AI agent 500 may be an AI agent configured to process input requests and generate computer code for a particular programming language, and AI agent 502 may be an AI agent configured to test computer code for various applications and use cases. However, it will be appreciated that the types or capabilities of AI agents 500, 502 as described above are for example purposes only and that any type of AI agent or any ability set for an AI agent may be used within the scope of the present disclosure.

In some implementations, dynamic workspace orchestration process 10 may process 306 one or more interactions with the one or more AI agents using content information defined within the secure dynamic workspace. Returning to the above example, dynamic workspace orchestration process 10 may deploy 304 AI agent 500 for generating new programming code and AI agent 502 for testing programming code for particular applications. In this example, dynamic workspace orchestration process 10 may process 306 one or more interactions with the AI agents 500, 502 using content information (e.g., content information 504, 506) defined within secure dynamic workspace 406. Content information 504, 506 may generally include data that is accessible to and consumable by AI agents within secure dynamic workspace 406. In one example, content information 504, 506 may be provided, created, or uploaded to secure dynamic workspace 406 by users (e.g., user 400). In another example, content information 504 may be created by AI agent 500 (e.g., programming code generated based on information provided by user 400) and consumed by AI agent 502 (a portion of the programming code generated by AI agent 500). In this example, AI agent 502 may generate content information 506 as the result of processing content information 504.

In some implementations, an interaction with an AI agent may generally include a portion of communication, request, response, or signal conveyed to or from an AI agent. As discussed above, dynamic workspace orchestration process 10 may process 306 one or more interactions with the AI agents by receiving requests for communication between users and AI agents within secure dynamic workspace 406. As will be discussed in greater detail below, dynamic workspace orchestration process 10 may process communication traffic internal or external to secure dynamic workplace 406 using a mesh protocol layer. In some implementations, processing 306 the one or more interactions with AI agent may include managing the interactions between AI agents and users. For example, dynamic workspace orchestration process 10 may generate a record (not shown) of the interactions between AI agents and users such that AI agents and/or users may access and search the one or more interactions. In another example, dynamic workspace orchestration process 10 may process 306 the interactions within secure dynamic workspace 406 by enabling AI agents 500, 502 with access to content information 504, 506. For example, dynamic workspace orchestration process 10 may receive content information 504, 506 from users and/or AI agents and may use cloud computing resources allocated to secure dynamic workspace 406 to store content information 504, 506 within secure dynamic workspace 406. Dynamic workspace orchestration process 10 may process interactions between the users and AI agents and may provide access to the content information (e.g., content information 504, 506) in response to identifying reference to the content information in the interactions. For example, dynamic workspace orchestration process 10 may process a link, an address, a description, or other reference to content information when processing 306 interactions with an AI agent and may, in response to processing the above references to content information, provide a requesting AI agent or user with access to the content information.

In some implementations, dynamic workspace orchestration process 10 may process 312 communication traffic for the secure dynamic workspace using a mesh protocol layer. For example and as discussed above, secure dynamic workspace 406 may include a mesh protocol layer (e.g., mesh protocol layer 414). In some implementations, dynamic workspace orchestration process 10 includes mesh protocol layer 414 through which all real-time communications within secure dynamic workspace 406 (e.g., user-to-user, user-to-AI agent, AI agent-to-AI agent, AI agent-to-tool, etc.) are conducted over the same protocol layer. Rather than segregating external traffic originating from client devices, such as web browsers or command-line interfaces, from internal traffic exchanged between microservices, and AI agent processes operating within the workspace, the mesh protocol layer 414 collapses all communications into a single protocol layer that handles user-to-server, user-to-user, AI agent-to-tool, and container-to-container interactions uniformly. For example, mesh protocol layer 414 may enforce participant identity within the scope of the secure dynamic workspace, message-level access control, and consistent logging across all participants.

In some implementations, mesh protocol layer 414 may utilize WebSocket connections, WebRTC channels, or other suitable real-time transport mechanisms to facilitate multi-party data exchange among all participants within the secure dynamic workspace. In one example, mesh protocol layer 414 may operate as a full mesh and, as such, any participant within secure dynamic workspace 406, whether a user, a command-line script, an AI agent, or an in-room tool, may send messages or data to any other participant in secure dynamic workspace 406 without requiring separate proxies, bridging solutions, or translation between different network layers. In some implementations, mesh protocol layer 414 may impose consistent authentication, routing, message ordering, and security scoping across all participants, such that access control policies governing which participants may read or write particular data are enforced uniformly within the single protocol rather than being distributed across separate internal cluster networking layers and external-facing ingress controllers as in conventional architectures which split these across multiple layers.

In one example, when secure dynamic workspace 406 is instantiated and user 400 establishes a connection (e.g., a WebSocket connection) to secure dynamic workspace 406, mesh protocol layer 414 routes the connection into secure dynamic workspace 406’s dedicated compute environment. AI agents (e.g., AI agents 500, 502) operating within secure dynamic workspace 406 and a plurality of users (e.g., users 400, 600, 602 using computing devices 402, 604, 606, respectively) each connect to mesh protocol layer 414. In this example, a user (e.g., user 600) or additional AI agent may join secure dynamic workspace 406 and may communicate with any other participant through the same mesh protocol layer (e.g., mesh protocol layer 414), with dynamic workspace orchestration process 10 applying consistent logging, ordering, and security enforcement to all message traffic without requiring any bridging or translation between internal and external network layers. This unified design simplifies integration, ensures consistent observability across all interactions within secure dynamic workspace 406, and eliminates the architectural complexity associated with maintaining separate communication stacks for different classes of participants.

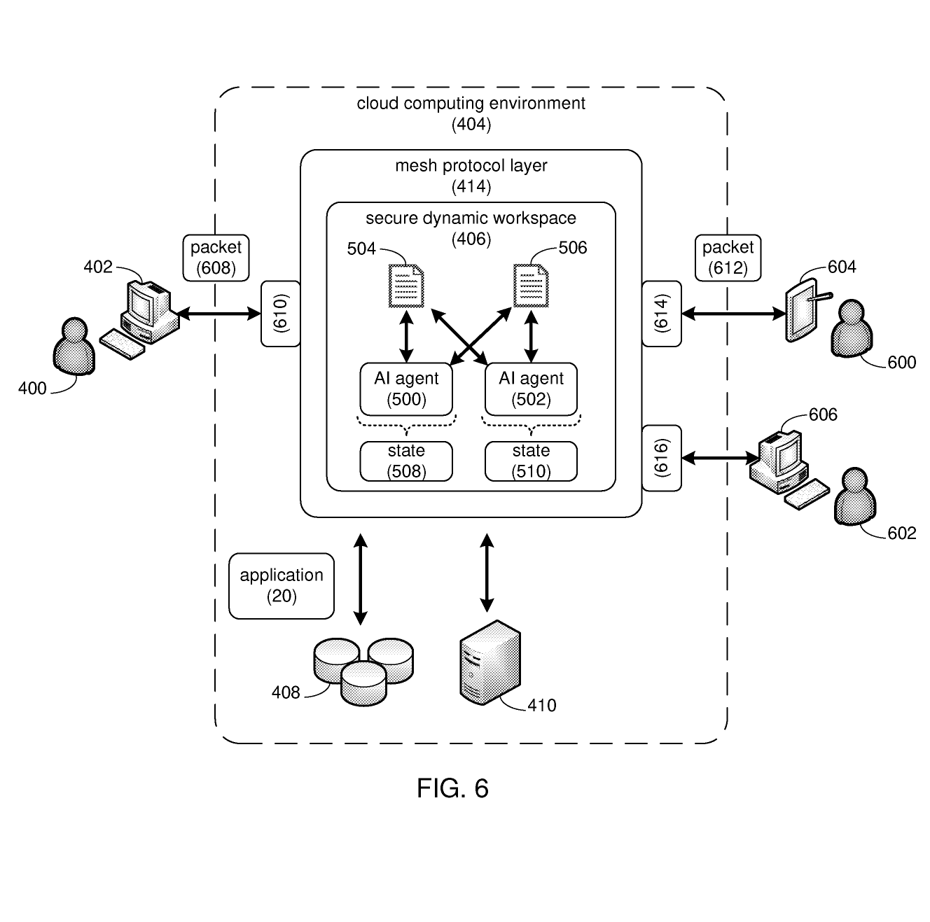

In some implementations, processing 312 communication traffic for the secure dynamic workspace using the mesh protocol layer includes: receiving 314 a communication packet from a first user at a first mesh protocol layer node associated with the secure dynamic workspace; processing 316 the communication packet within the secure dynamic workspace; and transmitting 318 the communication packet to a second user from a second mesh protocol layer node associated with the secure dynamic workspace. For example and referring again to FIG. 6, dynamic workspace orchestration process 10 may receive 312 a communication packet (e.g., communication packet 608) from a first user (e.g., first user 400) at a first mesh protocol layer node (e.g., first mesh protocol layer node 610) associated with secure dynamic workspace 406. A mesh protocol layer node (e.g., first mesh protocol layer node 610) may generally include a hardware and/or software component that enables signals from a user (e.g., first user 400 using computing device 402) to access mesh protocol layer 414. Dynamic workspace orchestration process 10 may process 314 communication packet 608 within secure dynamic workspace 406. Dynamic workspace orchestration process 10 may transmit 316 communication packet 612 to a second user (e.g., second user 600) from a second mesh protocol layer (e.g., second mesh protocol layer node 614). In this example, mesh protocol layer 414 may process 314 routing information identifying users, AI agents, and content information within secure dynamic workspace 406 to determine where to transmit 316 communication packet 612 to the second user (e.g., second user 600). While the above example concerns two users, it will be appreciated that any number of users accessing secure dynamic workspace 406 may use any number of mesh protocol layer nodes to perform various actions within the scope of the present disclosure (e.g., user 602 and mesh protocol layer node 616).

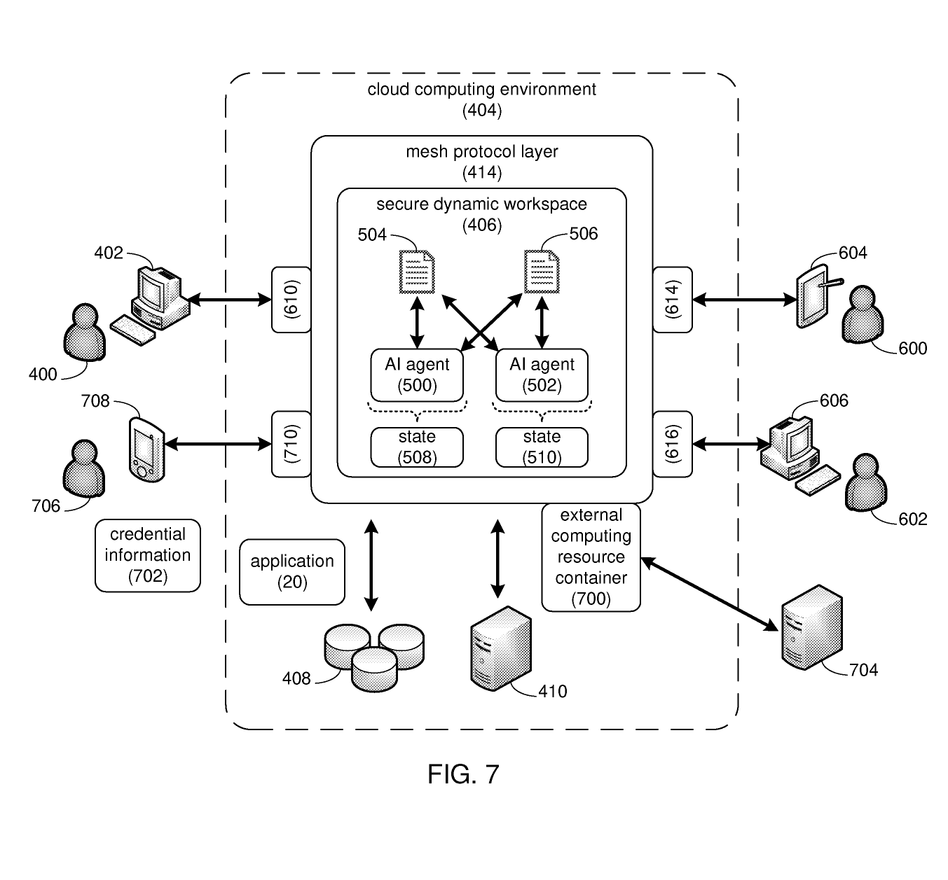

In some implementations, processing 306 the one or more interactions with the one or more AI agents may include managing 320 credential information for an external computing resource container accessible to the one or more AI agents. For example and referring also to FIG. 7, secure dynamic workspace 406 may include one or more external computing resource containers or “sidecar containers” (external computing resource container 700) that operate alongside secure dynamic workspace 406 within the same compute environment. An external computing resource container (external computing resource container 700) is a secondary container that runs within the same pod or compute unit as secure dynamic workspace 406 and provides auxiliary functionality, such as credential management, usage telemetry, logging, or network proxying, without requiring secure dynamic workspace 406 to incorporate that functionality directly. Accordingly, external computing resource container 700 may be configured to store or manage sensitive credentials (e.g., credential information 702), such as application programming interface (API) keys for large language model providers, on behalf of AI agents and tools operating within the workspace. Rather than permitting the AI agents or other tools within the workspace to hold raw provider credentials, external computing resource container 700 functions as a local credential proxy that generates and issues short-lived authentication tokens scoped exclusively to secure dynamic workspace 406 in which external computing resource container 700 operates. In this example, because credential management is scoped to each individual secure dynamic workspace 406, no centralized credential gateway is required that might commingle credentials across different tenants or workspace instances, thereby reducing the risk that an AI agent operating within one secure dynamic workspace could access credentials or data belonging to another workspace. In some implementations, external computing resource container 700 may generate and transmit usage telemetry tagged by secure dynamic workspace, AI agent, and/or user.

In one example, when an AI agent (e.g., AI agent 500) operating within secure dynamic workspace 406 receives a user request that requires invocation of a large language model, the AI agent transmits the request over the mesh protocol layer to external computing resource container 700 rather than directly to the external computing resource (e.g., external computing resource 704). External computing resource container 700 may authenticate the request using a short-lived internal token, retrieve the actual provider API key that is stored exclusively within external computing resource container 700’s isolated runtime environment, and may forward the authenticated request to external computing resource 704 on behalf of AI agent 500. Upon receiving the response from external computing resource 704, external computing resource container 700 returns the response to the requesting AI agent (e.g., AI agent 500) over the mesh protocol layer 414 and simultaneously emits usage telemetry, including prompt token counts, completion token counts, and request metadata, to dynamic workspace orchestration process 10’s observability and billing pipeline. This telemetry may be tagged with the workspace identifier, agent identifier, and user identifier, enabling granular, per-secure dynamic workspace usage tracking and billing without exposing raw credentials to any participant other than external computing resource container 700 itself. In this manner, external computing resource container 700 provides credential isolation, usage metering, and security enforcement as an integral component of the secure dynamic workspace, with credentials dynamically injected into secure dynamic workspace 406 at instantiation and automatically decommissioned when secure dynamic workspace 406 is terminated. In this example, a user (e.g., user 706) may communicate with secure dynamic workspace 406 using a computing device (e.g., computing device 708) and a mesh protocol layer node (e.g., mesh protocol layer node 710) and may provide credential information (e.g., credential information 702) to AI agent 500 for accessing external computing resource container 700 and external computing resource 704.

In some implementations, dynamic workspace orchestration process 10 may manage 308 a state for the one or more AI agents within secure dynamic workspace based upon, at least in part, the one or more interactions. For example, the state of an AI agent may generally include the totality of runtime memory, persistent data, configuration parameters / data, credential associations, conversation / interaction histories, intermediate computational results, generated artifacts (e.g., code, documents, etc.) and contextual information that an AI agent accumulates and maintains within secure dynamic workspace 406. In conventional stateless architectures, state is discarded after each request cycle, such that no memory is retained across successive interactions and each incoming request may be routed to a different server instance with no awareness of prior exchanges. This stateless model was designed for workloads in which every user performs substantially identical operations, such as uploading an image or viewing a content feed, and the server need not retain per-user context between requests. However, agentic workloads differ fundamentally in that each AI agent interaction may require significant per-user memory and processing power, including, for example, the retrieval of a custom code repository unique to a particular user, the loading of workspace-specific rules and data, and the retention of accumulated context from prior sessions. In some implementations, these operations are unique to each user and each secure dynamic workspace instance. As such, an AI agent’s working context cannot be discarded and rebuilt for every request without introducing unacceptable latency and loss of accumulated knowledge.

With dynamic workspace orchestration process 10, the state of each AI agent is managed 308 within secure dynamic workspace 406 to which AI agent is deployed, such that the AI agent’s runtime memory, loaded data, configuration, and accumulated context remain resident in secure dynamic workspace 406 across successive interactions and sessions. For example, when an AI agent (e.g., AI agent 500) is deployed 304 in secure dynamic workspace 406, the AI agent becomes specific to secure dynamic workspace 406’s context, meaning AI agent 500 acquires knowledge of the data, rules, files, and configuration parameters particular to secure dynamic workspace 406 and its participants, thereby differentiating it from the same AI agent definition deployed in a different secure dynamic workspace. In some implementations, AI agent 500’s state (e.g., state 508) is persisted through secure dynamic workspace 406’s persistent storage volume, shared file system, database, and message queues, all of which are co-located within the secure dynamic workspace 406’s security and compute boundary rather than residing in external systems. This enables AI agents 500, 502 to retain their working context, including conversation histories, generated artifacts, learned rules, and intermediate results, as states 508, 510 across process restarts and successive user sessions for the duration of secure dynamic workspace 406’s lifecycle, without requiring the reconstruction of states 508, 510 from external sources upon each new interaction.

In some implementations, the managing 308 of agent state (e.g., states 508, 510 for AI agents 500, 502) within secure dynamic workspace 406 further enables multiple AI agents operating within the same workspace to share access to common workspace resources, including the workspace file system, database tables, and message queues, while each AI agent’s executable process runs within its own isolated sub-container with individually configured permissions governing which resources it may read, write, or execute. For example, AI agent 500 may be granted read and write access to secure dynamic workspace file system and database to perform programming code generation tasks, while AI agent 502 operating may be restricted to read-only access to a designated folder and may be prohibited from accessing the database or sending external communications. Accordingly, each AI agent may operate in an isolated container yet have access to shared state information (e.g., states 508, 510) based upon AI agent permissions for each AI agent. In some implementations, AI agents may also be dynamically added to or removed from a running secure dynamic workspace without requiring the secure dynamic workspace to be restarted, with secure dynamic workspace 406 continuously monitoring the difference between its desired agent configuration and its current running state and reconciling any discrepancies by spinning up or tearing down agent sub-containers as needed. Accordingly, the stateful, workspace-scoped architecture stands in contrast to conventional stateless systems in which AI agents are ephemeral processes that retain no memory across requests and share no common workspace-level resources with other AI agents.

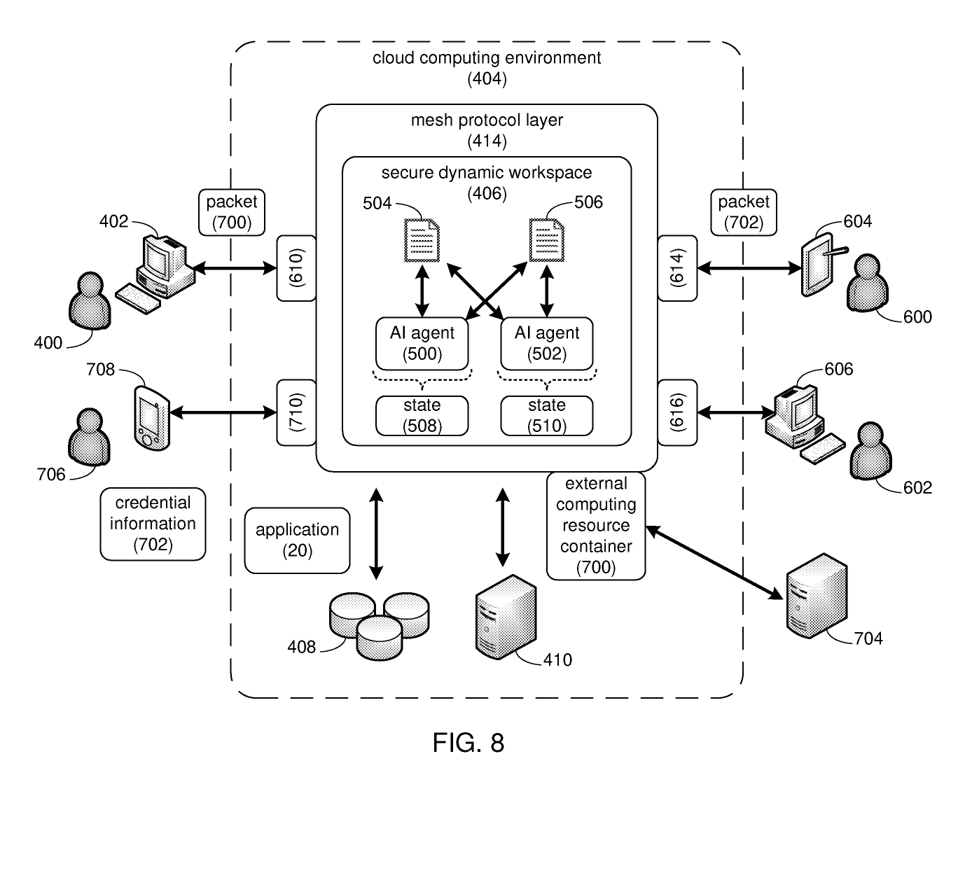

In some implementations, dynamic workspace orchestration process 10 may maintain 322 the secure dynamic workspace while a connection is identified by the mesh protocol layer between the secure dynamic workspace and at least one user. For example, dynamic workspace orchestration process 10 manages the lifecycle of secure dynamic workspace 406 based on the presence or absence of active, long-lived connections to secure dynamic workspace 406. As described above, participants, including users, command-line clients, and AI agents connecting from external environments, establish stateful, long-lived connections to secure dynamic workspace 406 through the mesh protocol layer, such as WebSocket connections, WebRTC data channels, or other persistent transport mechanisms. As shown in FIG. 8, dynamic workspace orchestration process 10 continuously monitors the set of active connections to secure dynamic workspace 406 and maintains awareness of which participants are presently connected. When a participant disconnects or a connection is otherwise terminated, dynamic workspace orchestration process 10 evaluates whether any remaining long-lived connections to the secure dynamic workspace persist. So long as at least one active connection remains (e.g., a WebSocket connection or a WebRTC data channel), dynamic workspace orchestration process 10 maintains 322 secure dynamic workspace 406, retaining its provisioned compute resources, persistent storage volume, running AI agent processes, and external computing resource containers. This connection-based lifecycle management differs from conventional approaches that rely on inactivity timers or request-rate thresholds, because the stateful protocol provides continuous, real-time awareness of participant presence rather than inferring occupancy from intermittent request traffic.

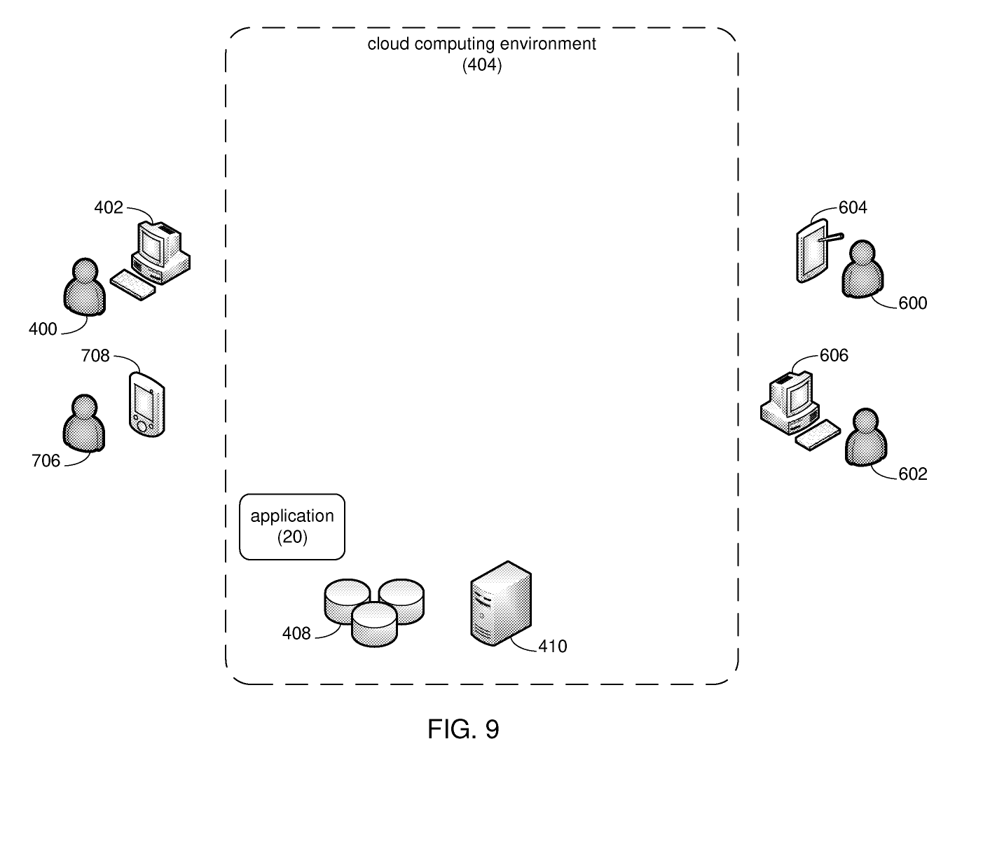

In some implementations, when dynamic workspace orchestration process 10 detects that no active long-lived connections remain to a given secure dynamic workspace, meaning that the last remaining participant has disconnected and no client sessions maintain an open connection, dynamic workspace orchestration process 10 initiates an automatic teardown process for the workspace. Referring also to FIG. 9, during teardown, dynamic workspace orchestration process 10 may deallocate the cloud computing resources associated with secure dynamic workspace 406, terminates running AI agents and external computing resource containers, detaches the persistent storage volume from the compute environment, and releases networking and routing resources that were allocated to secure dynamic workspace 406. The persistent storage volume itself may be retained in accordance with secure dynamic workspace 406’s configured data retention policy, such that it remains available for reattachment if secure dynamic workspace 406 is subsequently re-instantiated upon receipt of a new incoming connection, or it may be securely deleted in accordance with applicable data disposal policies if secure dynamic workspace 406 is permanently decommissioned. This automatic, connection-aware teardown ensures that cloud computing resources are consumed only while the secure dynamic workspace is actively in use, thereby reducing operational costs associated with idle workspaces and enabling the system to scale efficiently across large numbers of concurrently provisioned workspace instances.

In some implementations, dynamic workspace orchestration process 10 may include an integrated observability and billing pipeline that captures detailed telemetry for every action performed within secure dynamic workspace 406. Unlike conventional resource-based metering systems that measure only infrastructure-level metrics such as central processing unit hours or memory consumption, the observability and billing pipeline of dynamic workspace orchestration process 10 meters semantic-level and tool-level actions, including, without limitation, the number of large language model invocations, the number of prompt and completion tokens consumed per invocation, the number of tool calls executed by AI agents, file storage operations, and workspace lifecycle events such as pod creation and termination. Telemetry is captured at each service boundary within the secure dynamic workspace, including at the external computing resource container, the mesh protocol layer, and each AI agent process, and is tagged with fine-grained metadata comprising the workspace identifier, the user identifier, and the AI agent identifier. A real-time processing pipeline aggregates the captured telemetry and generates usage-based billing events contemporaneously with the occurrence of each metered action, enabling near-immediate, itemized usage tracking and invoicing on a per-secure dynamic workspace, per-user, and per-AI agent basis. This integrated approach provides granular visibility into application-level resource consumption within each secure dynamic workspace, in contrast to prior systems that capture only container-lifetime or infrastructure-utilization data for billing purposes.

In some implementations, dynamic workspace orchestration process 10 provides a set of cross-platform software development kits and an integrated visual development environment through which developers and operators interact with secure dynamic workspaces. Dynamic workspace orchestration process 10 may employ a protocol-first design in which client libraries implemented in multiple programming languages, including but not limited to Python, JavaScript, Dart, and C#, communicate with a secure dynamic workspace using the same wire protocol exposed by mesh protocol layer 414. In some implementations, workspace interactions, including messaging, tool invocations, file storage operations, large language model calls, and log streaming, may be abstracted into a single unified protocol. Accordingly, application code written in any supported programming language may connect to and interact with secure dynamic workspace 406 identically, without requiring language-specific adapters or translation layers. The integrated visual development environment utilizes the same real-time mesh protocol layer 414 channel to display active participants, live log streams, real-time cost and usage dashboards, and AI agent conversation histories within a consolidated interface. In some implementations, this may eliminate the conventional pattern in which container-based solutions require separate dashboards for orchestration management, separate logging solutions, and separate cost management tools, instead consolidating monitoring, debugging, and operational control into a single environment that operates over the same communication protocol used by production workloads. Developers may join an active secure dynamic workspace session through the visual development environment and observe, in real time, the same data streams and interactions processed by production agents and tools, thereby enabling live debugging and inspection without requiring separate instrumentation or secondary monitoring infrastructure.

### General

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms "comprises" and/or "comprising," when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, executed on a computing device, comprising:
processing a request for a secure dynamic workspace in a cloud computing environment;
in response to processing the request, generating the secure dynamic workspace in the cloud computing environment by provisioning a plurality of cloud computing resources for use within the secure dynamic workspace;
deploying one or more artificial intelligence (AI) agents within the secure dynamic workspace using the plurality of cloud computing resources;
processing one or more interactions with the one or more AI agents using content information defined within the secure dynamic workspace; and
managing a state for the one or more AI agents within secure dynamic workspace based upon, at least in part, the one or more interactions.

2. The computer-implemented method of claim 1, wherein the secure dynamic workspace is a virtual container configured to isolate the plurality of cloud computing resources based upon, at least in part, a security policy defined for the secure dynamic workspace.

3. The computer-implemented method of claim 1, further comprising:
processing communication traffic for the secure dynamic workspace using a mesh protocol layer.

4. The computer-implemented method of claim 3, wherein processing communication traffic for the secure dynamic workspace using the mesh protocol layer includes:
receiving a communication packet from a first user at a first mesh protocol layer node associated with the secure dynamic workspace;
processing the communication packet within the secure dynamic workspace; and
transmitting the communication packet to a second user from a second mesh protocol layer node associated with the secure dynamic workspace.

5. The computer-implemented method of claim 1, wherein processing the one or more interactions with the one or more AI agents includes managing credential information for an external computing resource container accessible to the one or more AI agents.

6. The computer-implemented method of claim 1, wherein generating the secure dynamic workspace in the cloud computing environment includes provisioning a persistent storage volume within the secure dynamic workspace.

7. The computer-implemented method of claim 1, further comprising:
maintaining the secure dynamic workspace while a connection is identified by the mesh protocol layer between the secure dynamic workspace and at least one user.

8. A computer program product residing on a non-transitory computer readable storage medium having a plurality of instructions stored thereon which, when executed across one or more processors, causes at least a portion of the one or more processors to perform operations comprising:
processing a request for a secure dynamic workspace in a cloud computing environment;
in response to processing the request, generating the secure dynamic workspace in the cloud computing environment by provisioning a plurality of cloud computing resources for use within the secure dynamic workspace;
deploying one or more artificial intelligence (AI) agents within the secure dynamic workspace using the plurality of cloud computing resources;
processing one or more interactions with the one or more AI agents using content information defined within the secure dynamic workspace; and
managing a state for the one or more AI agents within secure dynamic workspace based upon, at least in part, the one or more interactions.

9. The computer program product of claim 8, wherein the secure dynamic workspace is a virtual container configured to isolate the plurality of cloud computing resources based upon, at least in part, a security policy defined for the secure dynamic workspace.

10. The computer program product of claim 8, wherein the operations further comprise:
processing communication traffic for the secure dynamic workspace using a mesh protocol layer.

11. The computer program product of claim 10, wherein processing communication traffic for the secure dynamic workspace using the mesh protocol layer includes:
receiving a communication packet from a first user at a first mesh protocol layer node associated with the secure dynamic workspace;
processing the communication packet within the secure dynamic workspace; and
transmitting the communication packet to a second user from a second mesh protocol layer node associated with the secure dynamic workspace.

12. The computer program product of claim 8, wherein processing the one or more interactions with the one or more AI agents includes managing credential information for an external computing resource container accessible to the one or more AI agents.

13. The computer program product of claim 8, wherein generating the secure dynamic workspace in the cloud computing environment includes provisioning a persistent storage volume within the secure dynamic workspace.

14. The computer program product of claim 8, wherein the operations further comprise:
maintaining the secure dynamic workspace while a connection is identified by the mesh protocol layer between the secure dynamic workspace and at least one user.

15. A computing system including one or more processors and one or more memories configured to perform operations comprising:
processing a request for a secure dynamic workspace in a cloud computing environment;
in response to processing the request, generating the secure dynamic workspace in the cloud computing environment by provisioning a plurality of cloud computing resources for use within the secure dynamic workspace;
deploying one or more artificial intelligence (AI) agents within the secure dynamic workspace using the plurality of cloud computing resources;
processing one or more interactions with the one or more AI agents using content information defined within the secure dynamic workspace; and
managing a state for the one or more AI agents within secure dynamic workspace based upon, at least in part, the one or more interactions.

16. The computing system of claim 15, wherein the secure dynamic workspace is a virtual container configured to isolate the plurality of cloud computing resources based upon, at least in part, a security policy defined for the secure dynamic workspace.

17. The computing system of claim 15, wherein the processor is further configured to:
process communication traffic for the secure dynamic workspace using a mesh protocol layer.

18. The computing system of claim 17, wherein processing communication traffic for the secure dynamic workspace using the mesh protocol layer includes:
receiving a communication packet from a first user at a first mesh protocol layer node associated with the secure dynamic workspace;
processing the communication packet within the secure dynamic workspace; and
transmitting the communication packet to a second user from a second mesh protocol layer node associated with the secure dynamic workspace.

19. The computing system of claim 15, wherein processing the one or more interactions with the one or more AI agents includes managing credential information for an external computing resource container accessible to the one or more AI agents.

20. The computing system of claim 15, wherein generating the secure dynamic workspace in the cloud computing environment includes provisioning a persistent storage volume within the secure dynamic workspace.
